(19) United States
(12) Patent Application Publication
(10) Pub. No.: US 2015/0190920 A1
(43) Pub. Date: Jul. 9, 2015

(54) MODULE SYSTEM COMPRISING A CASE AND A NUMBER OF BOXES

(71) Applicant: Essve Produkter AB

(72) Inventors: Samuel Karlsson, Sollentuna (SE); Magnus Nilsson, Sollentuna (SE); Ove Larson, Sollentuna (SE)

(21) Appl. No.: 14/661,858

(22) Filed: Mar. 18, 2015

Related U.S. Application Data
(63) Continuation of application No. 13/517,228, filed on Aug. 29, 2012.

(30) Foreign Application Priority Data
Dec. 23, 2009 (SE) 0951020-7

(51) Int. Cl. B25H 3/02

(52) U.S. Cl. CPC B25H 3/02

(57) ABSTRACT

The present invention relates to a module system comprising a case and a number of boxes. Each box is defined by a cross-sectional area of an opening of the respective box. The case has a case lid and a case bottom part. The case lid and the case bottom part forms an interior space within the case, and the boxes are to be stored in the interior space of the case. The cross-sectional area of one box is approximately a multiple (n) of any cross-sectional area of any of the number of boxes that are to be stored in the interior space of the case. The case lid is provided with sealing means that sealingly fits over and in abutment with an upper surface of at least one box, with the case in closed position, when the boxes are stored in the interior space of the case.

### TECHNICAL FIELD

The present invention relates to a module system comprising a case and a number of boxes.

### BACKGROUND ART

In storage systems it is required that the customer/user, such as a workman, easily could equip himself/herself with the correct quantities of working material in an organised manner in order to perform his/her assignment. For instance, a carpenter is required, in advance, to fill his/her case/cases in an organised way with the necessary working material. In such case, the working material is usually filled from a storage system including screws, fasteners and nails. When the case/cases are filled with all necessary equipment, the carpenter is ready to go and hopefully able to carry out the tasks at the working location effectively and fast, without any delay due to disorder and/or shortage of working material.

A workman has often limited facilities to bring working material to the working location. Ideally, the workman only has to bring one or two cases including tools and other working material. However, many assignments require in particular that a large amount of working material, such that various fasteners or the like, are brought. Consequently, there is a problem regarding effectiveness and handling of the working material if the workman could not bring all the necessary working material.

The object of the present invention is to provide a module system comprising a case and a number of boxes, which overcomes the disadvantages of prior art. A further object is to provide an alternative solution in view of the state of the art and an improved module system for obtaining increased compaction of boxes within a case. It is also an object to provide an optimization and organisation of a working material in a case.

### SUMMARY OF THE INVENTION

The above mentioned objects are solved by the present invention, which relates to a module system comprising a case and a number of boxes. Each box is defined by a cross-sectional area of an opening of the respective box, the case have a case lid and a case bottom part, where the case lid and the case bottom part forms an interior space within the case, and the boxes are to be stored in the interior space of the case. The module system is characterised in that the cross-sectional area of one box is approximately a multiple of any cross-sectional area of any of the number of boxes that are to be stored in the interior space of the case, and the case lid is provided with sealing means that sealingly fits over and in abutment with an upper surface of at least one box, with the case in closed position, when the boxes are stored in the interior space of the case.

According to the solution of the present invention, it was realized that the user/customer/workman, such as a carpenter, can tailor his/her case content by filling the case with boxes directly from the shelf in the store. Hence, the case can be tailored with a desired assortment of material. With the module system according to the present invention, it is possible for a workman to organize his/her working material in a favourable way, such that a correct and adequate number of items can be filled in the boxes, respectively, and stored during transportation and handling in the case. A high packing degree can be obtained with the module system, which facilitates the handling for the user. Since the case lid is provided with sealing means, the case can be carried around with the case closed without running the risk that the contents in the open boxes are spread around in the interior of the case, even if some or all boxes are without a box lid. Another advantage with the module system, with the boxes that are packed and stored in the case, which then constitutes a desired assortment of boxes, is that the boxes in themselves can be sales units.

By the term “multiple” in this context is meant a number t, representing a smallest module in the module system, that can be written as t multiplied with an integer n (i.e. t·n), and where the product of to is an integer representing another larger module in the module system.

### BRIEF DESCRIPTION OF THE DRAWINGS

The invention will hereinafter be described with reference to an embodiment of the invention and the enclosed figures, where

FIG. 1A shows in a perspective front view a module system according to a first embodiment of the present invention, comprising a case filled with a number of boxes,

FIG. 1B shows in a perspective front view a similar module system as in FIG. 1A, according to a second embodiment,

FIG. 1C illustrates a detailed and enlarged view from the interior of the case shown in FIG. 1A,

FIG. 1D illustrates a further detailed and enlarged view of a section shown in FIG. 1C,

FIG. 1E shows the module system of FIG. 1B in a view from above,

FIG. 2 illustrates the module system of FIGS. 1B and 1E according to an alternative organisation and arrangement of the boxes,

FIG. 3 illustrates the module system of FIGS. 1B and 1E according to yet an alternative organisation and arrangement of the boxes, and

FIG. 4A-B shows further embodiments of the box lids and the boxes, according to the present invention.

### DETAILED DESCRIPTION

A module system according to an embodiment of the present invention will now be described by way of example only. The disclosure is not intended to limit the scope of the enclosed claims in any way.

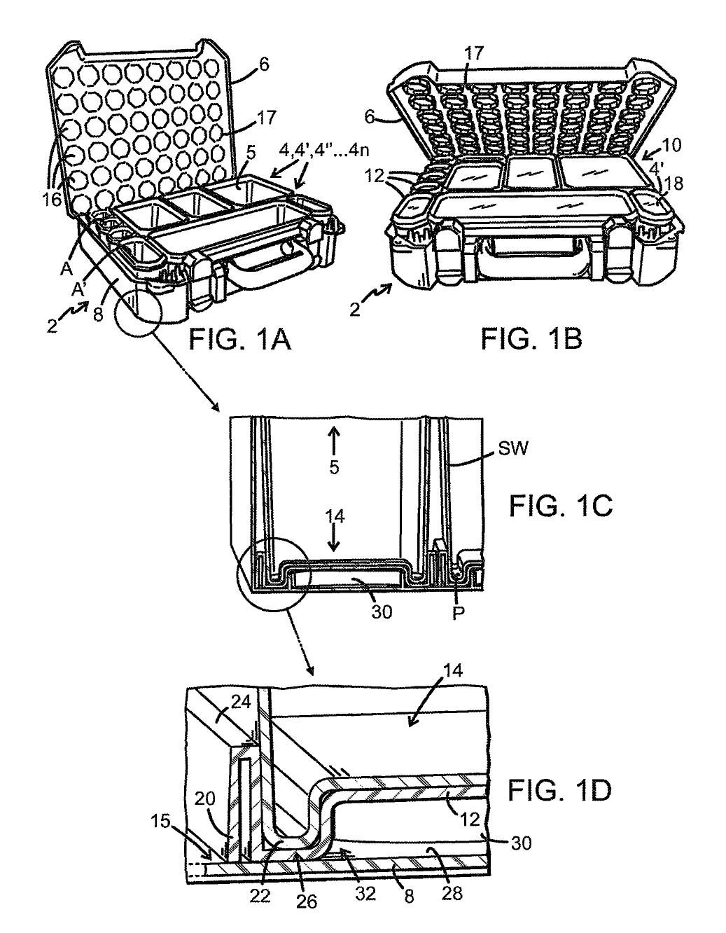

FIG. 1A shows a module system, according to a first embodiment of the present invention, comprising a case 2 and a number of boxes 4, 4′ . . . 4n. Each box is defined by a cross-sectional area, A, A′ . . . An, of an opening 5 of the respective box. Consequently, the cross-section for the defined cross-sectional area, A, A′ . . . An is taken at the opening 5 of the respective box, while other cross-sections of the box, such as closer to the bottom of a box, may have another cross-sectional area as described in detail here below. The case has a case lid 6 and a case bottom part 8. The case lid and the case bottom part forms an interior space 10 within the case 2. The boxes 4 are intended to be stored in the interior space 10 of the case 2. During use of the module system, the boxes can be taken out and lifted back into the case. The cross-sectional area A of one box 4 is approximately a multiple n of any cross-sectional area, A, A′ . . . An, of any of the number of boxes, 4, 4′ . . . 4n, that are to be stored in the interior space 10 of the case 2. As a result, a high degree of degree of compaction can be provided when the boxes are stored in the interior space 10 of the case 2. The degree of compaction is suitably at least about 90%. The degree of compaction can be expressed with other terms, such as in terms of filled area or non-open area in the case filled with boxes.

Hence, an essential part of the accessible space in the case can be filled with boxes, according to the solution of the present invention. Alternatively, instead of the expression in terms of the degree of compaction, the packing degree can be expressed as extent of available open area or available interior space that remains when the boxes are positioned and stored in the case. When the boxes are stored in the interior space 10 of the case 2, the available open area or available interior space is suitably below about 10%.

In the module system shown in FIGS. 1A-B, a smallest cross-sectional area A of a module 4 of one box 4, 4′ . . . 4n, in the module system, is a symmetrical polygon with equal sides. In that respect, the smallest cross-sectional area A of a module 4 of one box in the module system, is an octagon. That is a regular octagon, having equal sides with equal angles.

It is preferred according to the present invention, that each box has a lid 12. FIGS. 1B and 1E shows a similar module system as in FIG. 1A, according to a second embodiment. One difference is that the case 2 in FIGS. 1B and 1E are wider, such that the interior 10 includes one more module 4 along the width W of the short side 13 of the case 2. Another difference is that the boxes are provided with the lids 12. In other respects, the second embodiment in FIGS. 1B and 1E are similar to what is described and shown in the first embodiment.

Suitably, the cross-sectional area, A, A′ . . . An, of the modules 4, 4′ . . . 4n, respectively, are rotational symmetrical with respect to a centre C of the boxes, respectively.

The interior space 10 of the case 2 has preferably a cross-sectional area AC (see FIG. 1E) that is dimensioned such that it essentially corresponds to a multiple n of the cross-sectional area, A, A′ . . . An, of one box, 4, 4′ . . . 4n, in the module system.

Each box, 4, 4′ . . . 4n, has a bottom surface 14 as illustrated in FIGS. 1C-D. According to the first embodiment of the module system shown in FIG. 1A, box lids 12 are arranged on an inner surface 15 of the bottom part 8 of the case 2 and the boxes, 4, 4′ . . . 4n, are arranged with their bottom surfaces 14, respectively, on the corresponding box lid 12, respectively. The lids 12 are detachable from the opening 5 of the boxes. Preferably, the outer side walls SW of the boxes, 4, 4′ . . . 4n, are tapering from the opening 5 to the bottom surface 14. Consequently, sufficient space can be provided for arranging the box lids 12 on the bottom part 8 of the case 2 such that the boxes, 4, 4′ . . . 4n, are arranged with their bottom surfaces 14, respectively, on the corresponding box lid 12, respectively.

The respective box lid 12 has preferably a circumference 20 essentially corresponding to the cross-sectional area, A, A′ . . . An, of the opening 5 of the respective box 4, 4′ . . . 4n. The bottom surface 14 of the respective box 4, 4′ . . . 4n can comprise a projection 22 at the periphery P of the bottom surface 14. Each box lid 12 has an upper surface 18 comprising a rim 24 and a groove 26 arranged within the rim 24, the projection 22 of the bottom surface 14 of the box 4, 4′ . . . 4n is adapted to fit within the groove 26 of the box lid 12. In that respect, an inner surface 28 of the bottom part 8 of the case 2 can be provided with a plurality of projecting areas 30, the dimension of the projecting areas 30 are adapted such that they mates with the shape of respective bottom surface 14, within the projection 22, of the boxes 4, 4′ . . . 4n and a respective recess 32, formed within the groove 26, of the box lid 12, respectively.

A fully or partly loaded case should be possible to carry regardless if the boxes are closed, opened (box lid removed or thrown away) or opened with the box lids stored underneath the boxes, respectively, in the case. Suitably, the case lid 6 is provided with sealing means 16 on the inside 17 of the case lid 6 (see FIGS. 1A and 1E), facing the interior 10 of the case 2, that may sealingly fit over and in abutment with an upper surface 18 of the boxes, 4, 4′ . . . 4n. Especially in the embodiment where the boxes are left opened in the case 2, as disclose with reference to FIG. 1A, this is advantageous since the sealing means may keep the boxes and their content in place. As a result, when the case 2 is in closed position, and the boxes, 4, 4′ . . . 4n, are stored in the interior space 10 of the case 2, the sealing 16 means sealingly fit over and in abutment with the box lids 12 or the openings 5 of the boxes, 4, 4′ . . . 4n. The sealing can for instance be a foam material such as foam plastics or the similar.

Consequently, at least one box 4, 4′ . . . 4n may have an open and accessible opening 5 defined at the upper surface 18. The at least one box is stored in the case 2 with the opening 5 accessible when the case lid 6 is in a first opened position, with the case lid swung open. In a second closed position, in which the case lid 6 is in abutment towards the case bottom part 8, the opening 5 of said box is inaccessible. The sealing means 16 sealingly fits over and in abutment with the upper surface 18 of said box. The sealing means may comprise one or more sealing elements 16, distributed over substantially the whole inside 17 of the case lid 6. The sealing means can be formed of a flexible material made of foamed material such as foamed plastics or the similar.

Thanks to the sealing means, the case may also comprise a mixture of boxes that are provided with box lids 12 as well as boxes that have an accessible opening 5 defined at the upper surface 18 when the boxes are positioned and stored in the case 2.

As mentioned above, the interior space 10 of the case 2 can be dimensioned such that it essentially corresponds to a multiple n of the cross-sectional area, A, A′ . . . An, of one box, 4, 4′ . . . 4n, in the module system. As illustrated in FIG. 1E, an example of organisation and arrangement of the boxes, 4, 4′ . . . 4n, in the case 2 is shown. The boxes, 4, 4′ . . . 4n, in FIG. 1E are marked XS, S, M, L, EL, XL, in order from the smallest box to the largest box. Hence, a high degree of compaction can be achieved, suitably at least about 90%.

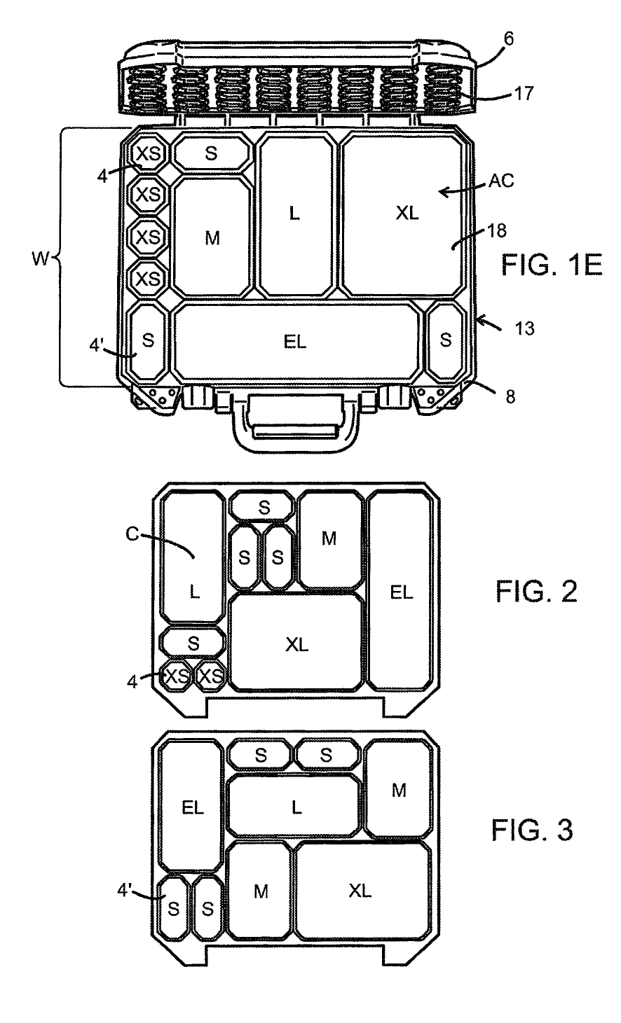

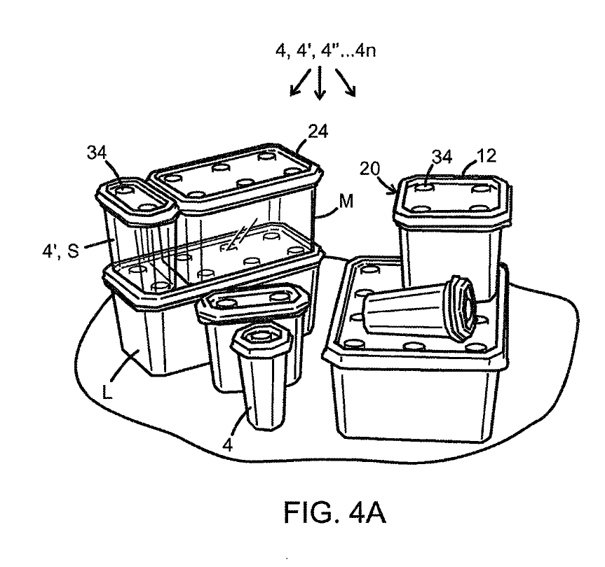

FIGS. 2-3 illustrates the module system according to two alternatives for organisation and arrangement of the boxes, 4, 4′ . . . 4n, marked XS, S, M, L, EL, XL, in the case 2. Hence, with these alternatives too, a high degree of compaction can be achieved, suitably at least about 90%.

As mentioned in the general description, the term “multiple” in this context means a number t, representing a smallest module in the module system, that can be written as t multiplied with an integer n (i.e. t·n), and where the product of to is an integer representing another larger module in the module system. In the module system, the smallest module having the smallest cross-sectional area A of a box 4 is represented by t=1 which is for the box marked XS in FIGS. 1E, 2 and 3. Consequently, the next smallest box 4′ marked S has t=2, etc. According to the present invention, another box 4, 4′ . . . 4n has a multiple n of the other box 4, 4′ . . . 4n in question, that are to be stored in the interior space 10 of the case 2. For example, another box 4n, for instance n=6, will be a multiple of box 4, XS, that is 1·6=6. The integer 6 represent the box marked M, that is a box 4n with about six times larger cross-sectional area An.

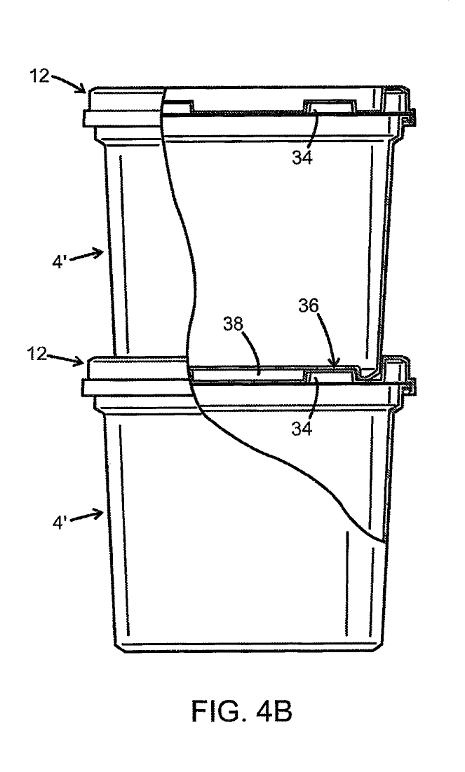

FIG. 4A shows one embodiment of the box lids and the boxes. The respective box lid 12 can be provided with one or more projecting areas 34, within the circumference 20 and the rim 24 of the box lid 12. The boxes 4, 4′ . . . 4n have recesses in the bottom surface 14 such that the bottom surface 14 fits over the projecting areas 34 of the box lids 12. Preferably, the extra small box 4, XS, is provided with a box lid 12 having one projecting area 34, and the small box 4′, S, is then provided with a box lid 12 having two projecting areas 34, etc. Consequently, e.g. a medium box marked M has six projecting areas 34. Thus, on top of the lid 12 of a large box L, a small box S and a medium box M can be securely positioned, as illustrated in FIG. 4A. The projecting areas 34 have suitably a circumference with an octagon shape.

FIG. 4B shows in a further embodiment the box lids and the boxes, according to the present invention, with the box lids 12 provided with projecting areas 34 as discussed with reference to FIG. 4A. Similar to the embodiment in FIG. 4A, the boxes 4, 4′ . . . 4n have recesses 36 in the bottom surface 14 such that the bottom surface 14 fits over the projecting areas 34 of the box lids 12. Additionally, the bottom surface 14 of the boxes can be provided with one or more protruding areas 38, which may also be the case in the embodiment in FIG. 4A. In the example shown in FIG. 4B, the protruding area 38 of the box 4′ is placed centrally of the bottom surface 14. Of course, within the scope of the present invention, there are other possible arrangements of the protruding areas 38 on the bottom surface 14.

1-13. (canceled)

14. A module system, comprising:
a case comprising a case lid and a case bottom part, wherein the case lid and the case bottom forms an interior space within the case; and
a number of boxes, each box being defined by a cross-sectional area of an opening of the respective box, the boxes are to be stored in the interior space of the case, and the cross-sectional area of one box is approximately a multiple of any cross-sectional area of any of the number of boxes that are to be stored in the interior space of the case, characterised in that the case lid and the case bottom part are so arranged that a box lid for at least one of the boxes is arrangeable between the at least one box and the case bottom part.

15. The module system according to claim 14, wherein the case lid and the case bottom part are arranged that, when the interior space is partly loaded with boxes, the case lid and the case bottom part keep the boxes and their content in place.

16. The module system according to claim 14, wherein at least one box has an open and accessible opening defined at the upper surface, and the at least one box is stored in the case with the opening accessible when the case lid is in a first opened position, with the case lid swung open, and where the opening is inaccessible when the case lid is in a second closed position, in which the case lid is in abutment towards the case bottom part, wherein the interior space within the case comprises stored boxes, and a remaining available open area within the case, such that the case is partly or fully loaded with boxes.

17. The module system according to claim 14, wherein each box has a bottom surface, where the box lids are arranged on the bottom part of the case and the boxes are arranged with their bottom surfaces, respectively, on the corresponding box lid, respectively.

18. The module system according to claim 14, wherein the respective box lid has a circumference essentially corresponding to the cross-sectional area of the opening of the respective box, each box has a bottom surface that comprises a projection at a periphery of the bottom surface, and that each box lid has an upper surface comprising a rim and a groove arranged within the rim, the projection of the bottom surface is adapted to fit within the groove of the box lid.

19. The module system according to claim 18, wherein an inner surface of the bottom part of the case is provided with a plurality of projecting areas, the dimension of the projecting areas are adapted such that they mates with the respective bottom surface of the boxes and a respective recess, formed within the groove, of the box lid, respectively.

20. The module system according to claim 18, wherein the case comprises a mixture of boxes that are provided with box lids as well as boxes that have an accessible opening defined at the upper surface when the boxes are positioned and stored in the case.

21. The module system according to claim 14, wherein a smallest cross-sectional area of a module in the module system that consists of one box, is a symmetrical polygon with equal sides.

22. The module system according to claim 21, wherein the smallest cross-sectional area of the module is an octagon.

23. The module system according to claim 14, wherein the cross-sectional area of modules, respectively, are rotational symmetrical.

24. The module system according to claim 14, wherein the interior space of the case has a cross-sectional area that is dimensioned such that it essentially corresponds to a multiple of the cross-sectional area of one box in the module system.

25. The module system according to claim 14, wherein each box comprises tapering side walls, that are tapering from an opening to a bottom surface.

26. The module system according to claim 14, wherein the case lid is provided with sealing means that sealingly fits over and in abutment with an upper surface of at least one box, with the case in closed position, when the boxes are stored in the interior space of the case.
